(19) United States
(12) Patent Application Publication
(10) Pub. No.: US 2006/0178983 A1
(43) Pub. Date: Aug. 10, 2006

(54) Mortgage broker system allowing broker to match mortgagor with multiple lenders and method therefor

(76) Inventors: Robert Nice, Pembroke Pines, FL (US); Richard Kwiat, Fort Lauderdale, FL (US); Rolando Garcia, Miramar, FL (US); Ramon Morales, Tamarac, FL (US)

Correspondence Address: Jeffrey H. Kamenetsky;CHRISTOPHER & WEISBERG, P.A., Suite 2040, 200 East Las Olas Boulevard, Fort Lauderdale, FL, 33301, US

(21) Appl. No.: 11/347,855

(22) Filed: Feb. 6, 2006

Related U.S. Application Data
(60) Provisional application No. 60/651,532, filed on Feb. 7, 2005.

(51) Int. Cl. G06Q 40/00

(52) U.S. Cl. 705/38

(57) ABSTRACT

A method and system for matching lending companies with prospective borrowers during an on-line loan prequalification process. The system includes a database for storing lender prequalification criteria received from one or more lenders over a communication network where the lender prequalification criteria include each lender's available loan products. The system also includes a server in communication with the database. The server receives loan prequalification requests from one or more loan requesters over the communication network such as the Internet, and provides real time loan prequalification matches in response to the loan prequalification requests. The loan prequalification matches are based upon a comparison of the loan prequalification requests with the lender prequalification criteria.

### CROSS-REFERENCE TO RELATED APPLICATION

This application is related to and claims priority to U.S. Provisional Patent Application Ser. No. 60/651,532, filed Feb. 7, 2005 entitled MORTGAGE BROKER SYSTEM ALLOWING BROKER TO MATCH MORTGAGOR WITH MULTIPLE LENDERS AND METHOD THEREFOR, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for matching lending companies with prospective purchasers and more specifically to a method and system for on-line brokering between purchasers and lenders that presents lender requirements and purchaser qualifications in an interactive manner allowing brokers to select the best deals for their clients in a minimal amount of time.

### BACKGROUND OF THE INVENTION

One of the most labor intensive and time consuming parts of getting a mortgage pre-qualified and then pre-approved is that each mortgage lender uses different lending criteria, which must be remembered by the mortgage broker. Most brokers must search for hours on each lender's often complex web site to determine if their client's loan qualifications fit into the lender's loan criteria, and then submit the loan for pre-qualification evaluation. A broker must perform this process on each lender's website, since multiple lenders are competing for the broker's business. This is a tedious, time consuming and expensive process.

The mortgage lending industry has two main categories for lending. The first is known as “prime” lending, which is typically bank loans for people with excellent credit and money to put down on the property. They are considered safe loans to banks and are underwritten by agencies like Fannie Mae®. For the most part, these loans are identical in nature, differing only by the rates that they charge. For many years the mortgage industry has had software companies collect this data and attempt to offer pricing catalogs to brokers for easy reference.

The other major category of lending is called “sub-prime,” which are loans are offered by many different types of banks and companies to people who may not qualify for “prime” loan products. Generally if the prospective purchaser's credit is sub-par, or if the purchaser doesn't have enough money to put down on the home, or if the purchaser falls below any other given criteria, then a “sub-prime” loan is often the only remaining option. The major hurdle for brokers trying to offer these products to their customers is that the criteria and pricing for each product at each lending facility is completely different.

A typical scenario for a sub-prime broker is to take the customer's application and submit it, either over the Internet or via fax, to each available lender. An account executive at the lender will then review the file and give a “pre qualification” on the loan if he or she believes it will be approved. This process often takes twenty-four hours or more, and is frustrating for both the broker and their client. Should the client need to change an item in the loan application, for example, their credit turns out to be not as good as they originally believed it to be, or the property is in a different city than they originally thought, then the process must be repeated, perhaps several times.

Brokers also make their living by receiving a commission from the lender that they introduce the borrower to. Brokers often do not know until pre-qualification what their commission will be for a given scenario or rate. Because of the time-consuming nature of searching, many brokers use only two or three “favorite” lenders and therefore often miss out on lenders who might pay a higher commission for the exact same loan.

Therefore, what is needed is a method and system that unifies the pre-qualification guidelines of each sub-prime lender, searches for pre-qualifications quickly and accurately, and presents lender candidates to the broker quickly and efficiently so the broker's client can be promptly notified and the best loan for the client can be selected.

### SUMMARY OF THE INVENTION

The present invention advantageously provides a method and system for facilitating on-line loan transactions between a loan requestor and one or more lending facilities by matching borrower loan information with lender underwriting criteria in a quick and efficient manner.

According to one aspect, the present invention provides a system for facilitating loan transactions. The system includes a database for storing lender prequalification criteria received from one or more lenders over a communication network where the lender prequalification criteria includes each lender's available loan products. The system also includes a server in communication with the database. The server receives loan prequalification requests from one or more loan requesters over the communication network and provides real time loan prequalification matches in response to the loan prequalification requests. The loan prequalification matches are based upon a comparison of the loan prequalification requests with the lender prequalification criteria.

In accordance with another aspect of the invention, a method for facilitating loan transactions is provided. The method includes receiving lender prequalification criteria from one or more lenders, where the lender prequalification criteria includes each lender's available loan products. The method further includes receiving loan prequalification requests from one or more loan requesters, and providing real time loan prequalification matches in response to the loan prequalification requests. The loan prequalification matches are based upon a comparison of the loan prequalification requests with the lender prequalification criteria.

In accordance with yet another aspect, the present invention provides a storage medium that stores a computer program which when executed by a processing unit performs a method for facilitating loan transactions. The method includes receiving lender prequalification criteria from one or more lenders, where the lender prequalification criteria includes each lender's available loan products, receiving loan prequalification requests from one or more loan requesters, and providing real time loan prequalification matches in response to the loan prequalification requests. The loan prequalification matches are based upon a comparison of the loan prequalification requests with the lender prequalification criteria.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a loan prequalification system in accordance with the present invention;

FIG. 2 is a flowchart illustrating the steps taken by the search engine of the present invention;

FIG. 3 is a flowchart illustrating the steps taken to determine changes in lender document information in accordance with the present invention; and

FIG. 4 is a flowchart illustrating the private investor auction embodiment of the present invention.

### DETAILED DESCRIPTION OF THE INVENTION

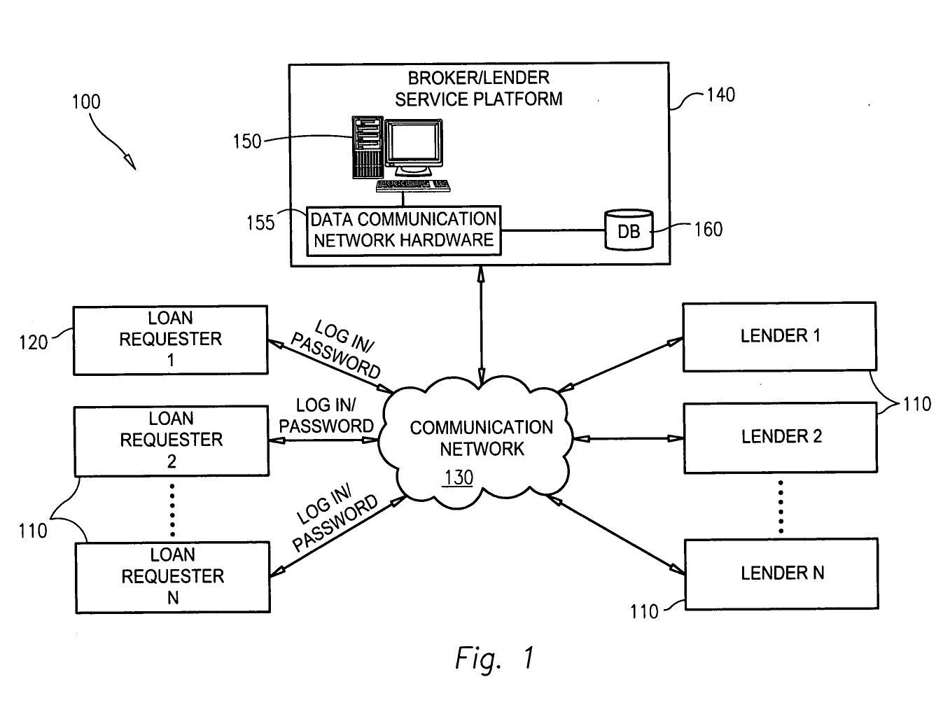

Referring now to the drawing figures in which like reference designators refer to like elements, there is shown in FIG. 1, a system constructed in accordance with the principles of the present invention and designated generally as “100.” System 100 represents a loan prequalification transaction system that facilitates the prequalification of loan requests. System 100 includes one or more lending facilities 110, one or more loan requester sites 120, a communication network 130, and a service platform 140.

Lending facility 110 typically includes a web site operated by a lending institution. The web site provides information regarding that lender's loan products, its interest rates, its commission rates paid out to brokers, and other related information. Loan requester sites 120 represent computers operated by individuals seeking a loan, or brokers that are searching for available loans for their customers. Loan requesters 120 contact service platform 140 via communication network 130, which could be, for example, the Internet.

Service platform 140 includes one or more network servers 150 capable of hosting a web site, and a database 160. The term “server” as used in this application refers to one more computers, network data communications hardware 155 and all software stored thereon. Server 150 stores a variety of web pages that can be accessed by browser software on a loan requester's and a lender's terminal, can receive borrower loan request applications and lender loan criteria, can retrieve information from both local and remote information storage databases, and can determine matches between information on borrower loan applications and information on lender's loan criteria documents.

Server 150 is operatively coupled to network hardware 155 to establish communication across communication network 130. Server 150 in platform 140 may be one or more personal computers, minicomputers, or mainframe computers, capable of offering data management, network administration and security. Network hardware 155 may consist of one or several processors that host a web site incorporating the present invention as well as standard computer storage components such as Random Access Memory (RAM), Read Only Memory (ROM) and hard disk storage devices, as well as external memory devices such as compact disks, magnetic tape and the like.

Server 150 includes processors that process the software instructions housed in storage components in order to carry out the search required to receive and process loan applications from various loan requesters 120, to receive and process lending criteria from various lending sites 110, and to determine which, if any loan requesters 120 offer loan products that match the needs of prospective borrowers.

Electrically coupled to network hardware 155 is database 160. Database 160 may be located within platform 140 but may also be located off-site or include a remote storage facility. Database 160 stores borrower loan applications, lender loan criteria, and stored search records for each borrower or broker. These records are created when a loan requestor 120 contacts the platform website and submits a loan application on behalf of his or her customer. Database 160 is preferably any known database system, such as a relational or object oriented database system, that can be programmed to support the data required to maintain a broker and lender listing, to store records for each broker, and to identify the records for each broker by their login information.

Communications network 130 couples network hardware 155 to lender terminals 110 and loan requestor terminals 120. Network 130 is preferably the Internet, but can be an intranet or virtual network, or any network capable of communicating data between terminals 110 and 120 and network hardware 155. Lender terminals 110 and loan requester terminals 120 may represent any type of known computers capable of supporting a web browser, such as Personal Computers (PCs), Personal Digital Assistants (PDAs), such a Palm Pilot™, a cell phone or an interactive television. The present invention is not limited by any particular physical communication device and can employ any device that provides graphical, interactive access to the Internet. Loan requestor sites 120 and lending facilities 110 communicate with the software in server 150 via their computer's web browsers. Thus, the software needed to operate system 100 resides in server 150, rather than on each loan requestor or lender's computers.

As can be seen in FIG. 1, each loan requester 120 must log onto a website hosted by platform 140 via a unique log in account number and identification password. Although loan requestor 120 may be the actual borrower, in the ensuing examples, we will define loan requester 120 as a broker that is seeking available loans for his or her customer. Broker 120 electrically contacts the platform's host website supporting the present invention to establish a user profile. The host website creates a user file in database 160. Each user profile preferably includes a user name and corresponding password, which the broker 120 uses each time they wish to use the service of the present invention. A broker at broker terminal 120 accesses server 150 via communication network 130. Firewalls, data encryption and other hardware and software security measures that are well known in the art may be used to insure that unauthorized users cannot gain access to server 150.

After broker 120 logs onto the host website with their username and password, they are presented with a menu screen that includes any relevant news that platform 140 wishes to communicate with broker 120. Broker 120 is presented with a screen that prompts them to enter the type of loan their customer is seeking. Brokers 120 may choose to search for any type of loan product such as prime or sub-prime loans, update their billing information, update their contact/account information and access other platform features.

A “prime” loan is defined as a loan that is typically offered by a well known lending institution with standard lending procedures and requirements. These loans are typically offered to borrowers with excellent credit and differ only by the interest rates attached to the loan. On the other hand, “sub-prime” loans are offered to borrowers whose credit may fall below the rating required by prime lenders. Another type of loan option falls between a prime and sub-prime loan and typically offers prime-type pricing but since they do not officially qualify as “prime” loans, they are underwritten as sub-prime loans.

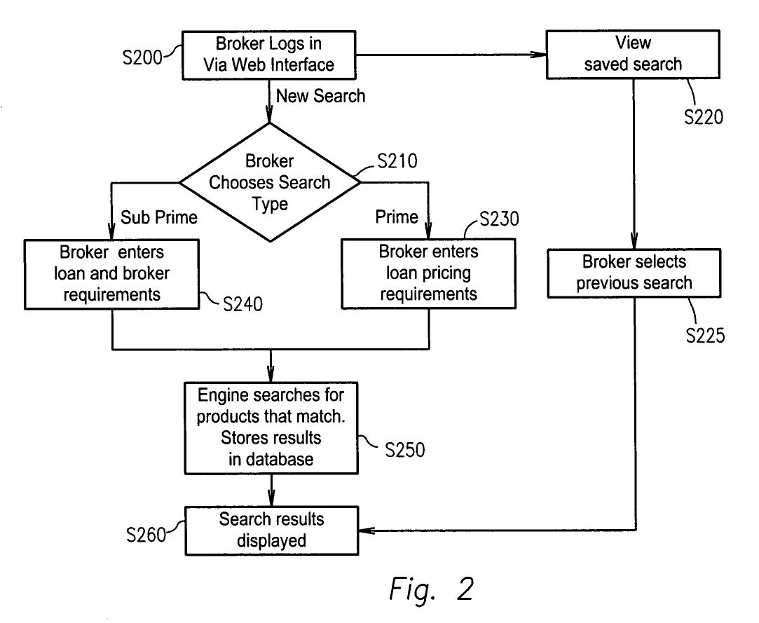

FIG. 2 is a flowchart illustrating steps taken by system 100 to facilitate a prequalification loan process between a loan requester 120 and one or more lending institutions 1 10 over communication network 130 in accordance with an embodiment of the present invention. At step S200, a broker 120 logs onto platform website 140 via a web interface, and creates a new account, or accesses an existing account. Each broker 120 is assigned a unique identification number and password in order to access website 140 and begin a new loan prequalification process or to access existing records. Upon logging onto website 140, brokers 120 will have access to all forms necessary to complete and submit a loan application from a loan requester. Once again, the term “broker” is being used as a general term that may include brokers, companies, individual borrowers or any other borrowing entity.

After broker 120 logs into platform website 140 with their username and password, they are presented with a menu screen that also includes any relevant news platform 140 wishes to communicate to brokers 120. Each broker 120 may choose to search for a particular type of loan, i.e., commercial, mortgage, prime, or sub-prime loan products, update their billing information, update their contact/account information and access other platform features, via step S210. When a broker 120 selects to search for a loan product, either prime or sub-prime, they are presented with a screen to enter the borrower's information. This screen also contains an index of all recent searches broker 120 has performed including basic summary information. Broker 120 may enter a new loan scenario or they may view and select a previously saved search from the index and quickly view the search results for that search, via steps S220 and S225. Any submitted loan scenario, i.e., a loan request submittal, is searched for and the results stored in the recent index.

Broker 120, upon receipt of the borrower's information, completes a loan request application for that borrower. The loan request application is stored in a highly encrypted and secure database with access limited to broker 120 and, perhaps the loan requestor. Database 160 contains all borrower applications for each broker 120, records of previous lender search matches, and records of all previous applications submissions, including to which lender each application was sent. The database also contains records of each lender's responses. The stored information allows broker 120 to review their client file at a later date.

If broker 120 elects to submit a loan request application for a prime loan, broker 120 enters the loan pricing requirements for the borrower, at step S230. Loans offered by prime lenders typically do not vary a great deal, other than by interest rate. However, if broker 120 elects to search for available sub-prime loans, via step S240, broker 120 enters an assortment of borrower and broker information in order for the search engine to search for all sub-prime lenders 110 that match some or all of the borrower and broker requirements.

System 100 of the present invention unifies the prequalification guidelines of every available sub-prime lender 110 by accessing sub-prime lending information from each lender 110 over communication network 130, storing this information in database 160, and running a search engine through server 150, which matches loan requestor applications with each lender's loan information. A “match” can be defined by different types of criteria. For example, a “match” could be if all of the lender criteria are met by the borrower's loan information. In another example, a “match” may occur if four out of seven loan conditions are met. In yet another example, a borrower's credit score of 600 may be required for a “match” to a particular lender's lending criteria to occur. Thus, a “match” is not limited to a particular threshold and may be set at any threshold by platform 140.

Based upon the search results, broker 120 can select the loan product that is best for both the customer and the broker 120. Should the customer change their loan criteria unexpectedly, it only takes a few clicks of a mouse to rerun the search. A new loan scenario consists of all the questions necessary to unify all of the loan programs at all of the different lenders that are supported.

Examples of types of information that a broker 120 might submit on behalf of a customer seeking a loan are the amount of the loan, the amount of the down payment, the type of loan (e.g., mortgage), if for a mortgage, the type of property (e.g. single family residence), the location of the property, the term of the loan and the borrower's credit history. Once this information is received from the borrower, the broker 120 can enter this information and submit it to server 150 via communication network 130. Sub-prime loan criteria typically vary quite a bit from lender to lender. Sub-prime lenders 110 will offer varying loan rates and will also offer a wide range of broker commission rates. Thus, the form that broker 120 submits may also include the commission they wish to make on the loan transaction, including, perhaps, a ceiling or maximum level.

Once broker 120 enters all the necessary information at step S240, they activate the search engine, via step S250. This step searches each of the lender documents which have been retrieved from the lender's website and stored in database 160 and determines which lender or lenders fit the needs of the broker's customer, as well as the broker. The results are displayed on the broker's computer screen, at step 260. Search results are also stored in database 160.

The displayed results of the search may include the rate of the loan, the terms, the required down payment, fees and other related information that will enable the broker 120 to make an informed decision as to which lender or lenders 110 meet his client's needs. Broker 120 can them submit a loan request application to one or more of the lenders 110 via communication network 130 for a prequalification determination.

For each loan product that is found to match the search criteria, a link is presented that provides access to the notes for the lender 110 and a breakdown of exactly how platform 140 reached the final rate for the loan product. This usually consists of a starting rate based on the loan scenario and adjustments for other loan scenario considerations. In addition, the broker's commission for each result and the credit grade can be displayed. Further, for each loan product displayed as a result of the running of the search engine, a communication link to the lender's website may also be provided. Broker 120 may also be provided with an interface that allows broker 120 to directly submit the loan scenario and the search results to the account executive at lender site 110 for submission. Brokers 120 may configure their own lender contacts from the main menu of the host website if they prefer dealing with a familiar contact person.

Platform 140 receives current, real-time loan criteria from each lender 110 that subscribes to the service. Loan criteria might, for example, include the types of loan products each particular lender 110 is offering, interest rates, minimal credit rating for a prospective borrower, and commission rates offered to brokers. This information is retrieved over communication network 130 and stored in database 160 in the form of lender “documents.”

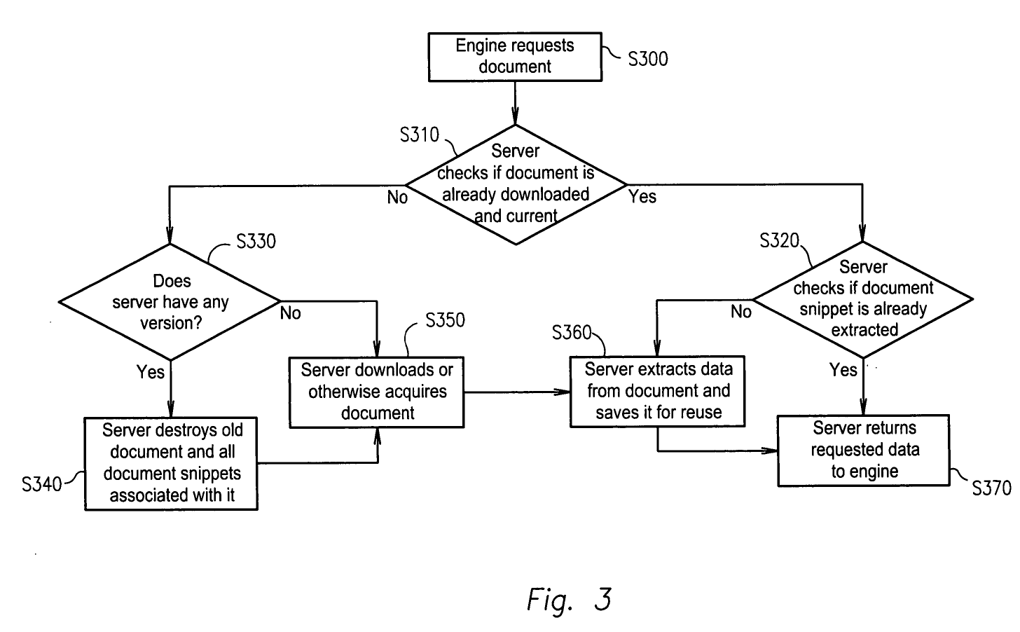

Platform 140 constantly monitors each lender's website in order to obtain the most current loan documents. Each change in loan information is documented and stored in database 160. FIG. 3 represents a flow chart showing the decisions made by the search engine in maintaining current loan documents for each lender 110. Referring to FIG. 3, the search engine requests a lender's document, at step S300. The document may include that lender's loan products, and associated lending criteria. Server 150 then checks to see if the document for that lender 110 has already been downloaded and stored in database 160, via step S310. If it has, server 150 then checks to see if information regarding lender criteria has been extracted from the document and stored, via step S320. If this is the case, server 150 returns the extracted data to the search engine, via step S370, where it will be compared to the borrower's loan request information upon the running of the search engine. Otherwise, server 150 extracts the lender criteria from the document and saves this information in database 160.

However, if server 150 determines, via step S330, that it does not have any information from a particular lender, server 150 acquires the latest lender document from lender 110 and stores this information in database 160, via step S350. If server 150 determines that database 160 already contains the lender document from a particular lender 110, but it is an older version, server 150 replaces the older document with the newer version, and extracts the necessary lender criteria from the document, which is then stored in database 160, via step S340. In this fashion, only the most current lender information is used by the search engine.

The present invention addresses the significant challenge of providing a search engine that takes into account the diversity of loan products and many differences in lending criteria formats. There is currently no fixed format for the documents provided by lenders 110 containing each lender's loan products and lending criteria. Documents provided by lenders 110 that contain loan products and lending criteria, particularly of the sub-prime variety, vary greatly in loan product type, business logic, and document formatting.

The present invention utilizes a graphical approach in capturing relevant lender criteria from lender documents posted on the lender's website by providing a graphical programming language that duplicates the lender's documents in a digital format, and provides suggestions to the search engine on how to read these documents. Thus, rather than create an algorithm that captures the business logic of each lender 110, or create a scripted language that represents each lender's logic, the present invention provides a graphical language that compares each lender's documents with a visually coded representation of them. The programming language utilized by the present invention directs the compiler to a physical location in the lender's document with instructions to obtain, for example, rate information, from this particular location in the document. Thus, when the lender updates their lending rates, platform 140 updates that lender's rates accordingly.

Lender documents containing loan criteria can be in virtually any format. Some lenders use Excel spreadsheets to provide their available loan products, lending rates, commission rates and related criteria. Other lenders use Adobe PDF documents, while others use plain text documents. The search engine utilizes a stand alone smart caching system capable of decoding each of the documents, indexing portions that are of interest and noticing when documents have been modified and then updating them accordingly.

The search engine constantly checks with each lender 110 via communication network 130 in order to obtain the latest version of the lender's loan document. For example, every two or three minutes, the search engine performs a search at all lender web sites for posted loan documents and compares them to what is stored in database 160. If a document from a requested lender 110 is not in database 160, the search engine briefly stops its search until it retrieves a copy of the requested document. Any changes in the document are quickly recognized and older versions stored in database 160 are replaced. In this fashion, brokers 120 can run the search engine with a customer on the phone, and inform them of all “matches,” i.e. lenders that are likely to prequalify their loan request.

The present invention is not limited to a scenario where only a broker is using the search engine of the present invention for its customer. Customers may utilize the search engine themselves. For the “consumer version,” customers must log onto server 150 in the same fashion as brokers, i.e. with a unique log on ID number and password. When a loan scenario is created or retrieved, results that are presented to the customer are similar to the results that are presented to a broker. Differences may include a flat commission that is added to the final price of the service fee to use platform 140. Another difference may be that the names of the lenders 110 are withheld so the host service can forward prequalified leads to the brokers who are members of the host service. In another embodiment, the host service provides the names of the lenders 110 who matched their loan scenario so the customers can contact each lender 110 in order to follow up with the loan process, or with the help of a broker if desired. Commercial loans may also be used in a similar fashion.

The invention is also not limited to a search for sub-prime loans only. The search may be for prime loans, sub-prime loans, or combinations of each, such as loans that are offered as prime-type loans but which are underwritten as sub-prime loans. However, there are scenarios that may arise where the search engine, after it has compared the borrowers loan information to each lender's prequalification criteria, does not find any “matching” lenders. In this scenario, the host platform 140 provides an alternate option by matching the borrower with private investors.

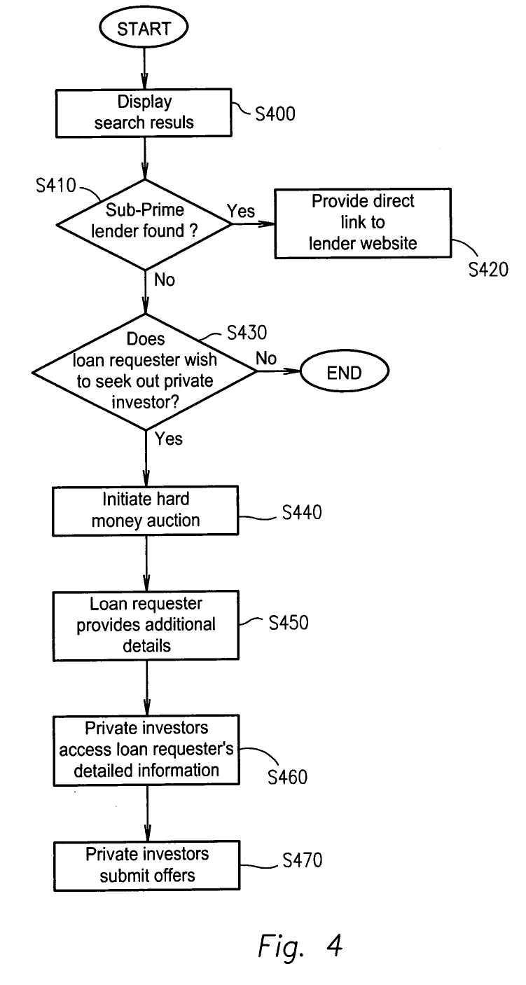

When a loan cannot qualify for any of the institutional lenders 110 in the system, the customer may be interested in receiving a loan from a private investor “Hard Money Auctions” allow borrowers and brokers to search for funds that are loaned from private investors. FIG. 4 provides a flowchart illustrating steps taken by system 100 when the results of the search engine utilizing the system 100 of the present invention reveals no qualified lenders. Broker 120 first views the search results, at step S400. For each loan product that is found to match the search criteria, a direct link is provided that shows the notes for the lender 110 and a breakdown of how final rate for that loan product was determined, via step S420. If no matches are found, a request is forwarded to the loan requestor to determine if they are interested in seeking out a private investor, via step S430

To initiate a Hard Money Auction, via step S440, broker 120 fills in details similar to those used in the traditional loan prequalification scenario, via step S450. Private investors can access the loan requestor's information via postings on the host platform 140, via step S460. Each investor then submits their offers, via step S470. Each auction lasts for a predetermined period of time and can be won by the highest bidder (i.e., the investor offering the lowest interest rate), or chosen by the loan requester based on their own criteria. This is a choice that is presented to the loan requestor prior to the start of the auction.

The Hard Money Auction may also be frequented by individual private investors looking for “deals” in which to invest their money. In this scenario, when the private investors log into the host web site of system 100, they can view a listing of the loan scenarios for those customers seeking investment in the Hard Money Auction. From reading the details relating to each customer, including all of the same information collected in the search performed by the search engine of the present invention, they can submit an offer that is managed through the host website.

Once a lender 110 receives a prequalification application submitted to them by broker 120, platform 140 provides a “received” response to let broker 120 know that the lender 110 has received the application. Once the application is reviewed by lender 110, a response is sent from lender 110 to platform 140. This response will be either an “approval” message or a “declined” message. All prequalification messages are sent to platform 140 and posted on the host website where they can be reviewed by broker 120. In this fashion, broker 120 can review all lender prequalification approvals and decide which lender 110 best meets his client's needs. Once broker 120 chooses a specific lender 110 and is satisfied with the terms of the prequalification document, broker 120 then provides all additional application information associated with the application, attaches this information to the prequalification document, and submits the loan application to lender 110 for pre-approval.

Once lender 110 receives the pre-approval application submission, a “received” response is provided to let broker 120 know that lender 110 has received the application. Once the application is reviewed, another response is sent from lender 110 to platform 140. This message approves the loan request, declines the request, or asks for additional information. All responses are saved in database 160.

The present invention can be realized in hardware, software, or a combination of hardware and software. An implementation of the method and system of the present invention can be realized in a centralized fashion in one computing system, or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A system for facilitating loan transactions, the system comprising:
a database for storing lender prequalification criteria received from one or more lenders over a communication network, the lender prequalification criteria including each lender's available loan products; and
a server in communication with the database, the server for receiving loan prequalification requests from one or more loan requesters over the communication network and for providing real time loan prequalification matches in response to the loan prequalification requests, the loan prequalification matches based upon a comparison of the loan prequalification requests with the lender prequalification criteria.

2. The system of claim 1, wherein the loan prequalification requests include borrower credit information.

3. The system of claim 1, wherein the loan prequalification requests include the desired broker commission requirements.

4. The system of claim 1, wherein the lender prequalification criteria includes real time interest rates for the loan product.

5. The system of claim 1, wherein if the comparison of the loan prequalification request and the lender prequalification criteria produces a loan prequalification match, further comprising a communication link between the loan requester and the lender that prequalified the loan request.

6. The system of claim 1, wherein if the comparison of the loan prequalification request and the lender prequalification criteria does not a prequalification match, further comprising a communication link between the loan requester and an alternate source of funds.

7. The system of claim 1, wherein the loan product is a mortgage.

8. The system of claim 1, wherein the lender prequalification criteria includes the broker commission rates offered by that lender.

9. The system of claim 1, where the loan requester is a broker.

10. A method for facilitating loan transactions, the method comprising:
receiving lender prequalification criteria from one or more lenders, the lender prequalification criteria including each lender's available loan products;
receiving loan prequalification requests from one or more loan requesters; and
providing real time loan prequalification matches in response to the loan prequalification requests, the loan prequalification matches based upon a comparison of the loan prequalification requests with the lender prequalification criteria.

11. The method of claim 10, wherein the loan prequalification requests include borrower credit information.

12. The method of claim 10, wherein the loan prequalification requests include the desired broker commission requirements.

13. The method of claim 10, wherein the lender prequalification criteria includes real time interest rates for the loan product.

14. The method of claim 10, wherein if the comparison of the loan prequalification request and the lender prequalification criteria produces a loan prequalification match, further comprising providing a communication link between the loan requester and the lender that pre-qualified the loan request.

15. The method of claim 10, wherein if the comparison of the loan prequalification request and the lender prequalification criteria does not a prequalification match, further comprising providing a communication link between the loan requester and an alternate source of funds.

16. The method of claim 10, wherein the loan product is a mortgage.

17. The method of claim 10, wherein the lender prequalification criteria includes the broker commission rates offered by that lender.

18. The method of claim 10, where the loan requestor is a broker.

19. The method of claim 10, further comprising determining if the lender prequalification criteria are the most recent criteria available for that lender, and if not, replacing previous versions of prequalification criteria with the most current version.

20. A storage medium storing a computer program which when executed by a processing unit performs a method for facilitating loan transactions the method comprising:
receiving lender prequalification criteria from one or more lenders, the lender prequalification criteria including each lender's available loan products;
receiving loan prequalification requests from one or more loan requesters; and
providing real time loan prequalification matches in response to the loan prequalification requests, the loan prequalification matches based upon a comparison of the loan prequalification requests with the lender prequalification criteria.

21. The storage medium of claim 20, wherein the loan prequalification requests include borrower credit information.

22. The storage medium of claim 20, wherein the loan prequalification requests include the desired broker commission requirements.

23. The storage medium of claim 20, wherein the lender prequalification criteria includes real time interest rates for the loan product.

24. The storage medium of claim 20, wherein if the comparison of the loan prequalification request and the lender prequalification criteria produces a loan prequalification match, the method further comprises providing a communication link between the loan requester and the lender that pre-qualified the loan request.

25. The storage medium of claim 20, wherein if the comparison of the loan prequalification request and the lender prequalification criteria does not a prequalification match, the method further comprises providing a communication link between the loan requester and an alternate source of funds

26. The storage medium of claim 20, wherein the loan product is a mortgage.

27. The storage medium of claim 20, wherein the lender prequalification criteria includes the broker commission rates offered by that lender.

28. The storage medium of claim 20, where the loan requestor is a broker.

29. The storage medium of claim 20, where the method further comprises determining if the lender prequalification criteria are the most recent criteria available for that lender, and if not, replacing previous versions of prequalification criteria with the most current version.
